(19) United States
(12) Patent Application Publication
(10) Pub. No.: US 2023/0082761 A1
(43) Pub. Date: Mar. 16, 2023

(54) SYSTEMS AND METHODS FOR DEVICE MONITORING

(71) Applicant: WUHAN UNITED IMAGING HEALTHCARE CO., LTD., Wuhan (CN)

(72) Inventors: Yonghui Ruan, Shenzhen (CN); Musheng LI, Wuhan (CN)

(73) Assignee: WUHAN UNITED IMAGING HEALTHCARE CO., LTD., Wuhan (CN)

(21) Appl. No.: 17/932,283

(22) Filed: Sep. 14, 2022

(30) Foreign Application Priority Data
Sep. 14, 2021 (CN) 202111074353.2
Sep. 17, 2021 (CN) 202111095130.4

(51) Int. Cl. G05B 23/02; G05B 13/04; G06K 9/62

(52) U.S. Cl. CPC G05B 23/0235; G05B 23/024; G05B 13/048; G06K 9/6256

(57) ABSTRACT

Systems and methods for device monitoring. The method may include obtaining first measurement data relating to one or more first operating parameters of a target device, obtaining a correlation model corresponding to the target device, and predicting, based on the first measurement data and the correlation model, second measurement data relating to the one or more second operating parameters of the target device. The correlation model may be generated based on first sample measurement data relating to the one or more first operating parameters and one or more second operating parameters of a reference device. The reference device may be of a same type of device as the target device and equipped with one or more additional sensors compared with the target device, the one or more additional sensors being configured for collecting the first sample measurement data relating to the one or more second operating parameters.

### CROSS-REFERENCE TO RELATED APPLICATIONS

This application claims priority to Chinese Patent Application No. 202111074353.2, filed on Sep. 14, 2021, and Chinese Patent Application No. 202111095130.4, filed on Sep. 17, 2021, the contents of each of which are hereby incorporated by reference.

### TECHNICAL FIELD

The present disclosure generally relates to device monitoring, and in particular, to systems and methods for determining operating parameters of a device.

### BACKGROUND

Traditionally, in order to ensure the normal use of a device (for example, a medical device) and automatically control the device, it is necessary to monitor the device in real-time using a plurality of sensors and negative feedback regulating circuits mounted on the device. However, the existing device probably has a limited amount of sensors, and it is costly and difficult to mount additional sensors on the existing device. Besides, as the automatic control method becomes more and more complex, a large number of sensors and negative feedback regulating circuits need to be installed when using traditional technology, resulting in higher control cost of the device. Therefore, it is desirable to provide systems and methods to monitor the device by limited sensors and control the device with low costs.

### SUMMARY

According to a first aspect of the present disclosure, a method for device monitoring may be executed by at least one processor. The method may comprise obtaining first measurement data relating to one or more first operating parameters of a target device. The method may also comprise obtaining a correlation model corresponding to the target device. The correlation model may be generated based on first sample measurement data relating to the one or more first operating parameters and one or more second operating parameters of a reference device. The reference device may be of a same type of device as the target device and equipped with one or more additional sensors compared with the target device, the one or more additional sensors being configured for collecting the first sample measurement data relating to the one or more second operating parameters. The method may further comprise predicting, based on the first measurement data and the correlation model, second measurement data relating to the one or more second operating parameters of the target device.

In some embodiments, the method may further comprise obtaining environment data of the target device, and modifying, based on the environment data and a first environment model, the second measurement data.

In some embodiments, the first environment model may include a plurality of association rules between the one or more first operating parameters and the one or more second operating parameters, each of the plurality of association rules corresponding to one of a plurality of types of environment. In some embodiments, the modifying, based on the environment data and a first environment model, the second measurement data may comprise selecting, from the plurality of association rules, a target association rule corresponding to an environment of the target device, and modifying, based on the first measurement data and the target association rule, the second measurement data.

In some embodiments, the obtaining a correlation model corresponding to the target device further may comprise obtaining environment data of the target device, and selecting, from a plurality of candidate correlation models each of which corresponds to one of a plurality of types of environment, the correlation model based on the environment data.

In some embodiments, the predicting, based on the first measurement data and the correlation model, second measurement data relating to the one or more second operating parameters of the target device may comprise obtaining environment data of the target device, and predicting the second measurement data based on the first measurement data, the correlation model, and the environment data, the correlation model being generated based on sample environment data of the reference device.

In some embodiments, the method may further comprise assessing an operating state of the target device based on the first measurement data and the second measurement data.

In some embodiments, the assessing an operating state of the target device based on the first measurement data and the second measurement data may further comprise determining, based on the first measurement data and the second measurement data, an assessment score of the operating state of the target device using a performance evaluation model.

In some embodiments, the method may further comprise modifying, based on environment data, the assessment score using a second environment model.

In some embodiments, the performance evaluation model may be obtained according to a process including obtaining a plurality of training samples, each of the plurality of training samples including second sample measurement data of the reference device and a sample assessment score of an operating state of the reference device, and generating the performance evaluation model by training a preliminary performance evaluation model using the plurality of training samples. The sample assessment score may be determined based on sample image data collected by the reference device under the second sample measurement data.

In some embodiments, the performance evaluation model may include a performance degradation evaluation model.

In some embodiments, the method may further comprise obtaining an operating parameter determination model corresponding to the target device, and determining one or more parameter values of the one or more first operating parameters and the one or more second operating parameters to be used by the target device at a future time based on the first measurement data, the second measurement data, and the operating parameter determination model.

According to a second aspect of the present disclosure, a system for device monitoring may include at least one storage device and at least one processor configured to communicate with the at least one storage device. The at least one storage device may include a set of instructions. When the at least one processor executes the set of instructions, the at least one processor may be directed to perform one or more of the following operations. The at least one processor may obtain first measurement data relating to one or more first operating parameters of the target device, obtain a correlation model corresponding to the target device, the correlation model being generated based on first sample measurement data relating to the one or more first operating parameters and one or more second operating parameters of a reference device, the reference device being of a same type of device as the target device and equipped with one or more additional sensors compared with the target device, the one or more additional sensors being configured for collecting the first sample measurement data relating to the one or more second operating parameters, and predict, based on the first measurement data and the correlation model, second measurement data relating to the one or more second operating parameters of the target device.

According to a third aspect of the present disclosure, a method for device monitoring may be executed by at least one processor. The method may comprise obtaining one or more first parameter values relating to one or more operating parameters of a target device, the one or more first parameter values reflecting an operating state of the target device at a first time, obtaining an operating parameter determination model corresponding to the target device, and determining, based on the one or more first parameter values and the operating parameter determination model, one or more second parameter values relating to the one or more operating parameters to be used by the target device at a second time after the first time.

In some embodiments, the determining, based on the one or more first parameter values and the operating parameter determination model, one or more second parameter values relating to the one or more operating parameters to be used by the target device at a second time after the first time may comprise determining, based on the one or more first parameter values and the operating parameter determination model, one or more target parameter values relating to the one or more operating parameters, and determining, based on the one or more first parameter values and the one or more target parameter values, the one or more second parameter values.

In some embodiments, the determining, based on the one or more first parameter values and the one or more target parameter values, the one or more second parameter values may comprise determining whether the one or more first parameter values and the one or more target parameter values meet a preset condition. In some embodiments, in response to determining that the one or more first parameter values and the one or more target parameter values do not meet the preset condition, the method may comprise, for each operating parameter, determining a difference between the first parameter value and the target parameter value of the operating parameter, and for each operating parameter, adjusting the first operating parameter value based on the corresponding difference to obtain an adjusted first parameter value of the operating parameter. In some embodiments, the method may further comprise determining, based on the one or more adjusted first parameter values and the operating parameter determination model, one or more adjusted target parameter values of the one or more operating parameters, determining whether the one or more adjusted first parameter values and the one or more adjusted target parameter values meet the preset condition, and in response to determining that the one or more adjusted first parameter values and the one or more adjusted target parameter values meet the preset condition, designating the one or more adjusted first parameter values as the one or more second parameter values.

In some embodiments, the method may further comprise obtaining environment data of the target device, and wherein the one or more second parameter values are determined further based on the environment data.

In some embodiments, the operating parameter determination model may be obtained according to a process including obtaining a plurality of training samples, each of the plurality of training samples including one or more preliminary sample parameter values relating to the one or more operating parameters of a sample device and one or more target sample parameter values relating to the one or more operating parameters of the sample device, and generating the operating parameter determination model by training a preliminary operating parameter determination model using the plurality of training samples.

In some embodiments, the obtaining a plurality of training samples may comprise for each of at least a portion of the plurality of training samples, obtaining a plurality of sets of sample image data each of which being collected by the corresponding sample device under a reference operating state, selecting, from the plurality of sets of sample image data, one or more sets of sample image data whose qualities satisfy a preset condition, and determining the one or more target sample parameter values based on the reference operating state of the sample device under which each selected set of sample image data is collected.

In some embodiments, the one or more operating parameters may include one or more first operating parameters and one or more second operating parameters. In some embodiments, the obtaining one or more first parameter values relating to one or more operating parameters of the target device may comprise obtaining the one or more first parameter values of the one or more first operating parameters measured by one or more first sensors mounted on the target device; obtaining a correlation model corresponding to the target device, and predicting, based on one or more first parameter values relating to the one or more first operating parameters and the correlation model, the one or more first parameter values relating to the one or more second operating parameters.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary monitoring system according to some embodiments of the present disclosure;

FIG. 2 is a schematic diagram illustrating another exemplary monitoring system according to some embodiments of the present disclosure;

FIG. 3 is a schematic block diagram illustrating an exemplary processing device according to some embodiments of the present disclosure;

FIG. 4 is a schematic block diagram illustrating another exemplary processing device according to some embodiments of the present disclosure;

FIG. 5 is a flowchart illustrating an exemplary process for determining second measurement data relating to one or more second operating parameters of a target device according to some embodiments of the present disclosure;

FIG. 6 is a schematic diagram illustrating an exemplary process for determining second measurement data according to some embodiments of the present disclosure;

FIG. 7 is a flowchart illustrating an exemplary process for evaluating an operating state of a target device according to some embodiments of the present disclosure;

FIG. 8 is a flowchart illustrating an exemplary process for determining a control instruction for a target device according to some embodiments of the present disclosure;

FIG. 9 is a flowchart illustrating an exemplary process for determining one or more second parameter values relating to one or more operating parameters to be used by a target device at a second time according to some embodiments of the present disclosure; and

FIG. 10 is a flowchart illustrating an exemplary process for determining second parameter value(s) according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “unit,” “module,” and/or “block” used herein are one method to distinguish different components, elements, parts, section or assembly of different level in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included of connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The present disclosure provides systems and methods for device monitoring. Specifically, the systems may utilize a correlation model to predict second measurement data relating to second operating parameter(s) of a target device based on first measurement data relating to first operating parameter(s) of the target device. The first measurement data relating to the first operating parameter(s) may be collected by first sensor(s) mounted on the target device. The correlation model may be generated based on sample measurement data relating to the first operating parameter(s) and the second operating parameter(s) of a reference device. The reference device may be of a same type of device as the target device, and mounted with the first sensor(s) and one or more additional second sensors. The first sensor(s) mounted on the reference device may be used to collect the sample measurement data relating to the first operating parameter(s) of the reference device, and the second sensor(s) mounted on the reference device may be used to collect the sample measurement data relating to the second operating parameter(s) of the reference device. The correlation model may be trained using the sample measurement data to learn complex relationships between the first operating parameter and the second operating parameter. Therefore, even if the target device is equipped with a limited amount of sensors (e.g., the first sensor(s)), more measurement data (i.e., the second measurement data relating to the second operating parameter(s)) reflecting the operating state of the target device may be predicted by the correlation model. In this way, the first measurement data in combination with the second measurement data may comprehensively reflect the operating state of the target device, and the device monitoring performed thereon may have an improved accuracy. In addition, the utilization of the correlation model may obviate the need of installing additional sensors on the target device, which may save equipment cost and human resources. Moreover, the reference device of a specific type may be used in monitoring multiple devices having the specific type. In other words, only one or a limited number of reference devices may need to be used for generating a correlation model that is applicable for multiple devices. Therefore, the systems disclosed herein may be used to achieve centralized monitoring of large number of devices with a relatively lower cost and a higher efficiency.

In some embodiments, the environment data of the target device may be collected and used to determine the second measurement data relating to the second operating parameter(s) of the target device. Thus, the effect of the environment may be considered and accurate second operating parameter(s) may be obtained.

In some embodiments, the systems disclosed by the present disclosure may utilize an operating parameter determination model to process first parameter value(s) relating to operating parameter(s) of the target device that reflect an operating state of the target device at a first time, and determine second parameter value(s) relating to the operating parameter(s) to be used by the target device at a second time after the first time. The second parameter value(s) may be regarded as optimal or desired parameter value(s) used by the target device at the second time. For example, under the second parameter value(s), a set of image data with good quality may be collected by the target device. By using the operating parameter determination model, the second parameter value(s) relating to the operating parameter(s) to be used by the target device at the second time may be determined without negative feedback regulating circuits.

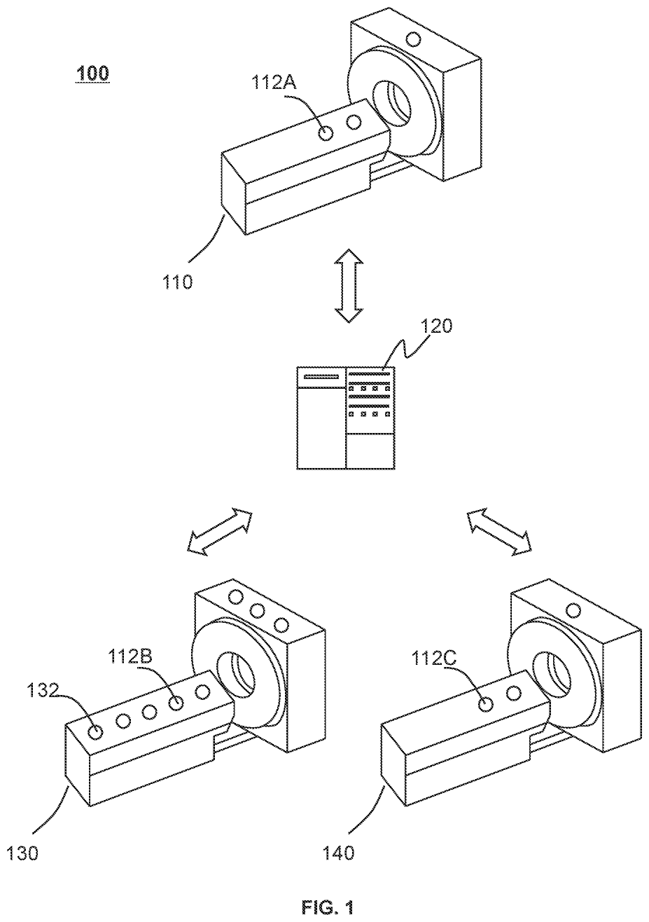

FIG. 1 is a schematic diagram illustrating an exemplary monitoring system 100 according to some embodiments of the present disclosure. The monitoring system 100 may also be referred to as a digital twin system. As illustrated in FIG. 1, the monitoring system 100 may include a target device 110, a processing device 120, a reference device 130, and a sample device 140. The monitoring system 100 may be used to monitor the operating state of the target device 110. In some embodiments, the components of the monitoring system 100 may be connected to and/or communicate with each other via a wireless connection, a wired connection, or a combination thereof. The connections between the components in the monitoring system 100 may be variable. For example, the target device 110 may be connected to the processing device 120 through a network. As another example, the target device 110 may be connected to the processing device 120 directly.

The target device 110 may be a device that needs to be monitored. In some embodiments, the target device 110 may be monitored using one or more first sensors 112A mounted on or outside of the target device 110. For example, the one or more first sensors 112A may collect first measurement data relating to one or more first operating parameters of the target device 110.

The target device 110 may be a medical device, a numerical control working equipment, a computer, a production equipment, and so on. In some embodiments, the medical device may be used for medical imaging and/or medical treatment. In some embodiments, the medical device may include an imaging device. The imaging device may include a single modality imaging device and/or a multi-modality imaging device. The single modality imaging device may include, for example, an X-ray imaging device (e.g., a computed tomography (CT) imaging device, a digital subtraction angiography (DSA) imaging device, a digital radiology (DR) imaging device, a computed radiology (CR) imaging device, etc.), an ultrasound imaging device (e.g., a color Doppler flow imaging (CDFI) device), a magnetic resonance imaging (MRI) device, or a nuclear medical imaging device (e.g., a positron emission tomography (PET) imaging device, a single photon emission computed tomography (SPECT) imaging device, etc.), etc. The multi-modality imaging device may include, for example, a computed tomography-magnetic resonance imaging (MRI-CT) device, a positron emission tomography-magnetic resonance imaging (PET-MRI) device, a single photon emission computed tomography-magnetic resonance imaging (SPECT-MRI) device, a digital subtraction angiography-magnetic resonance imaging (DSA-MRI) device, a positron emission tomography-magnetic resonance imaging-computed tomography (PET-CT) imaging device, etc. In some embodiments, the medical device may include a treatment device. The treatment device may include a treatment plan device (TPS), an image-guide radiotherapy (IGRT) device, etc.

The reference device 130 may be of the same type of device as the target device 110 and equipped with one or more additional sensors compared with the target device 110. The one or more additional sensors may be configured for collecting measurement data relating to the second operating parameter(s) of the reference device 130. The one or more additional sensors may be also referred to as one or more second sensors 132. In other words, the reference device 130 may include one or more first sensors 1126 (which are the same as the one or more first sensors 112A of the target device 110) and the one or more second sensors 132. In some embodiments, the one or more second sensors 132 may be mounted on the reference device by an engineer of a manufactor of the reference device. Exemplary second sensors may include a thermometer, a pressure gauge, a flow meter, and so on.

In some embodiments, two devices may be deemed as being of the same type if the two devices have the same function. For example, two CT scanners having the same product model may be deemed as being of the same type. As another example, two CT scanners produced in the same production batch may be deemed as being of the same type.

In some embodiments, since the reference device 130 is equipped with more sensors than the target device 110, the reference device 130 may provide reference information for monitoring the target device 110. In some embodiments, the reference device 130 may provide training data for generating one or more models that can be used to monitor the target device 110. Merely by way of example, first sample measurement data relating to the first operating parameter(s) and the second operating parameter(s) of the reference device 130 may be collected. The first sample measurement data relating to the first operating parameter(s) and the second operating parameter(s) may be used to generate a correlation model corresponding to the target device 110. The correlation model may indicate a correlation between the first operating parameter(s) and the second operating parameter(s). For example, the first measurement data relating to the first operating parameter(s) of the target device 110 may be inputted into the correlation model, and the correlation model may output second measurement data relating to the one or more operating parameter(s) of the target device 110. In some embodiments, the reference device 130 may send the first sample measurement data to the processing device 120. The processing device 120 may train a preliminary correlation model using the first sample measurement data to generate the correlation model.

The sample device 140 may be of the same type of device as the target device 110 and also include one or more first sensors 112C (which are the same as the one or more first sensors 112A of the target device 110). In some embodiments, the target device 110 may act as the sample device 140. In some embodiments, similar to the reference device 130, the sample device 140 may also be equipped with one or more additional sensors (or referred to as second sensors) compared with the target device 110. In some embodiments, the reference device 130 may act as the sample device 140.

In some embodiments, a plurality of training samples may be collected using the sample device 140, each of the plurality of training samples including one or more preliminary sample parameter values relating to the one or more operating parameters and one or more target sample parameter values relating to the one or more operating parameters. The plurality of training samples may be used to generate the operating parameter determination model. In some embodiments, the sample device 140 may send the plurality of training samples to the processing device 120. The processing device 120 may train a preliminary operating parameter determination model using the plurality of training samples to generate the operating parameter determination model. The operating parameter determination model may be used to recommend suitable parameter values to be used by the target device at a future time. For example, the operating parameter determination model may determine, based on first parameter value(s) relating to the operating parameter(s) of the target device that reflect an operating state of the target device at a first time, second parameter value(s) relating to the one or more operating parameters to be used by the target device at a second time after the first time.

The processing device 120 may process data and/or information obtained from the target device 110, the reference device 130, and the sample device 140. In some embodiments, the processing device 120 may predict second measurement data relating to the second operating parameter(s) of the target device 110 using the correlation model based on the first measurement data collected by the first sensor(s) 112A. In some embodiments, the processing device 120 may obtain one or more first parameter values relating to one or more operating parameters of the target device 110 that reflects an operating state of the target device 110 at a first time. The processing device 120 may determine one or more second parameter values relating to the one or more operating parameters to be used by the target device 110 at a second time after a first time using the operating parameter determination model. In some embodiments, the processing device 120 may generate one or more models used for monitoring the target device 110 (e.g., the correlation model, the operating parameter determination model) by model training.

In some embodiments, the processing device 120 may be a single server or a server group. The server group may be centralized or distributed. In some embodiments, the processing device 120 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the processing device 120 may be implemented on a computing device that includes a processor, a storage, an input/output (I/O), and a communication port.

For the convenience of description, the monitoring system 100 in FIG. 1 merely includes one target device, one reference device, and one sample device. This is not intended to be limiting. For example, the processing device 120 may be a big data center connecting to a plurality of target devices, a plurality of reference devices, and a plurality of sample devices. The target devices, the reference devices, and the sample devices may be located at the same region or different regions. Merely by way of example, the target devices may include a large amount of medical devices located in various hospitals. The reference devices and/or the sample devices may be located at their respective manufacturers' region. In some embodiments, the number of the target devices may be larger than the number of the reference devices and the number of the sample devices. For example, one reference device 130 may be used to generate a correlation model corresponding to one specific type of medical devices, and multiple medical devices of the specific type may be monitored using the correlation model by the processing device 120. For illustration purposes, the following descriptions describe device monitoring methods using one reference device and one sample device. It should be noted that the device monitoring methods may be implemented using multiple reference devices and/or multiple sample devices. For example, the correlation model may be generated using sample measurement data of multiple reference devices.

It should be noted that the above description of the monitoring system 100 is merely provided for the purposes of illustration, and not intended to limit the scope of the present disclosure. For persons having ordinary skills in the art, multiple variations and modifications may be made under the teachings of the present disclosure. For example, the monitoring system 100 may include one or more additional components and/or one or more components of the monitoring system 100 described above may be omitted. Additionally or alternatively, two or more components of the monitoring system 100 may be integrated into a single component. A component of the monitoring system 100 may be implemented on two or more sub-components.

In some embodiments, the monitoring system 100 may further include one or more other components, such as a network, a terminal, and a storage device. The network may include any suitable network that can facilitate the exchange of information and/or data for the monitoring system 100. The terminal may enable interactions between a user and the monitoring system 100. The storage device may store data and/or instructions. For example, the storage device may store training samples collected using the sample device 140. In some embodiments, the storage device may store data and/or instructions that the processing device 120 may execute or use to perform exemplary methods described in the present disclosure.

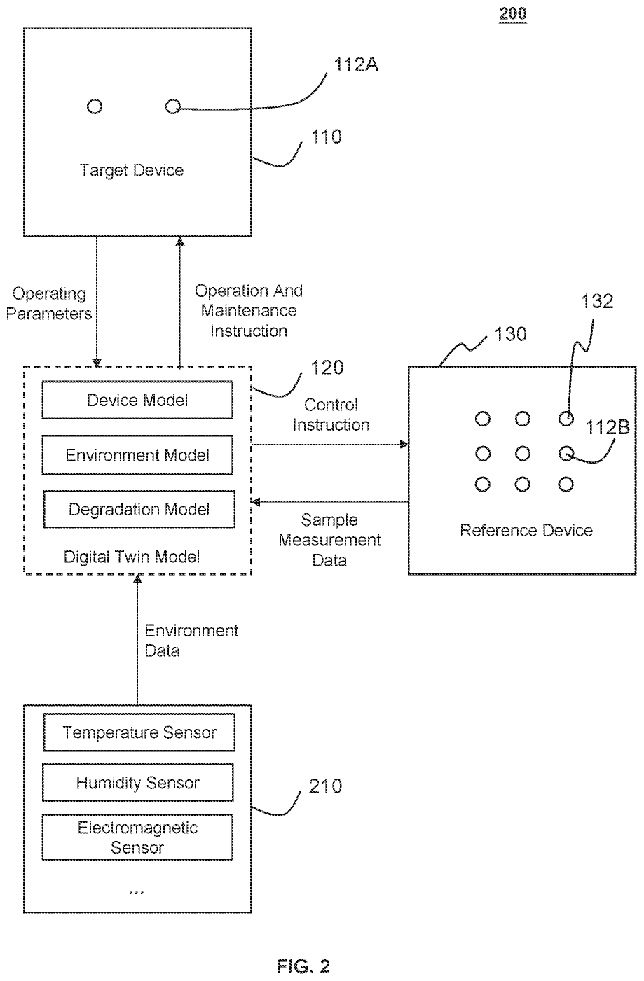

FIG. 2 is a schematic diagram illustrating another exemplary monitoring system 200 according to some embodiments of the present disclosure. As illustrated in FIG. 2, the monitoring system 200 may include the target device 110, the reference device 130, one or more environment sensors 210, and the processing device 120. The target device 110 may be equipped with the one or more first sensors 112A. The reference device 130 may be equipped with the one or more first sensors 112B and the one or more second sensors 132.

The one or more environment sensors 210 may be configured to collect environment data relating to the environment around the target device 110. In some embodiments, the environment sensor(s) 210 may be mounted around the target device 110. For example, the environment sensor(s) 210 may be mounted in the room where the target device 110 is located. The environment sensor(s) 210 may include a thermometer, a hygrometer, an electromagnetic field measuring instrument (for example, a Gauss meter), an altimeter (for example, an atmospheric pressure altimeter, a GPS, and so on), a barometer, and so on. The environment sensor(s) 210 may be used to detect the temperature, the humidity, the atmospheric pressure, the electromagnetic interference, the altitude, the air pH, the power supply current stability, or the like, or any combination thereof. In some embodiments, the environment sensor(s) 210 may send the environment data of the target device 110 to the processing device 120.

In some embodiments, environment data of the reference device 130 may be obtained. The environment data of the reference device 130 may be collected by one or more sensors, which are similar to the sensor(s) 210, mounted around the reference device 130. In some embodiments, the environment of the reference device 130 may be set to simulate the environment around the target device 110. In some embodiments, the environment data of the reference device 130 may include the temperature, the humidity, the atmospheric pressure, the electromagnetic interference, the altitude, the air pH, the power supply current stability, and so on. In some embodiments, the environment data of the reference device may be referred to as the sample environment data.

The processing device 120 may process data and/or information obtained from the target device 110, the reference device 130, and the environment sensor(s) 120. In some embodiments, the processing device 120 may generate one or more digital twin models for monitoring the target device 110 based on the data and/or information relating to the reference device 130. For example, based on the data and/or information relating to the reference device 130, the processing device 120 may generate the correlation model, a first environment model, and a performance evaluation model (e.g., a performance degradation evaluation model). The first environment model may include a plurality of association rules between a first operating parameter and a second operating parameter. Each association rule may correspond to one of a plurality of environment types and be used to modify the second measurement data relating to the second operating parameter if the environment of the target device 130 belongs to the environment type. The performance evaluation model may be used to evaluate, based on the first measurement data relating to the first operating parameter(s) and the second measurement data relating to the second operating parameter(s), the operating state of the target device 130 (e.g., determine an assessment score). In some embodiments, the performance evaluation model may include a performance degradation evaluation model.

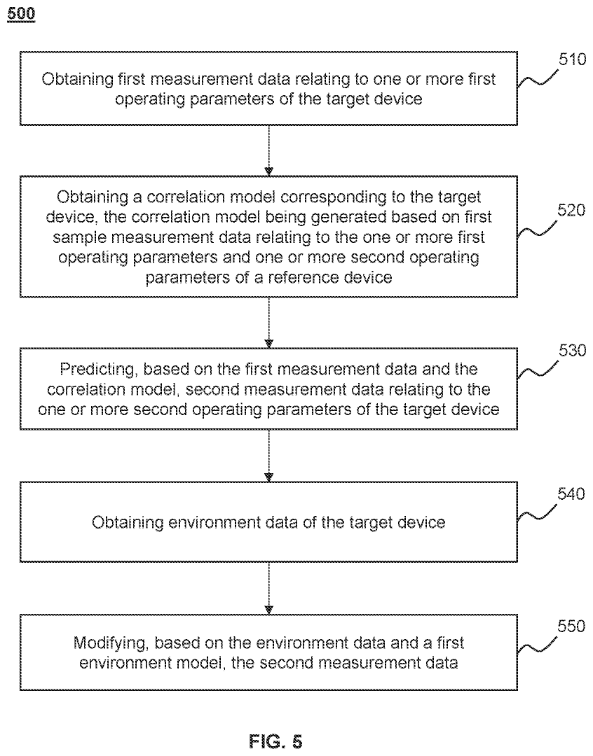

In some embodiments, the environment of the reference device 130 may be specially set to simulate different types of environments of the target device 110, such as a high-temperature environment, a low-temperature environment, a high humidity environment, a high altitude environment, a high electromagnetic field environment, and so on. For each of the types of environment, the processing device 120 may generate a corresponding candidate correlation model based on first sample measurement data of the reference device 130 collected under the type of environment. In application, the processing device 120 may receive the environment data of the target device 110, and select a candidate correlation model from the candidate correlation models as the correlation model corresponding to the target device 110 based on the environment data of the target device 110. In some embodiments, the processing device 120 may perform environment modeling based on the environment data and the first sample measurement data of the reference device 130 to generate the first environment model. In some embodiments, the first environment model may include a plurality of first environment sub-models. Each first environment sub-models may correspond to one type of environment of the plurality of types of environment. In some embodiments, the first environment model includes a plurality of association rules between the first operating parameter(s) and the second operating parameter(s), each of the plurality of association rules corresponding to one of a plurality of types of environment. More descriptions regarding the association rules may be found elsewhere in the present disclosure, e.g., FIG. 5.

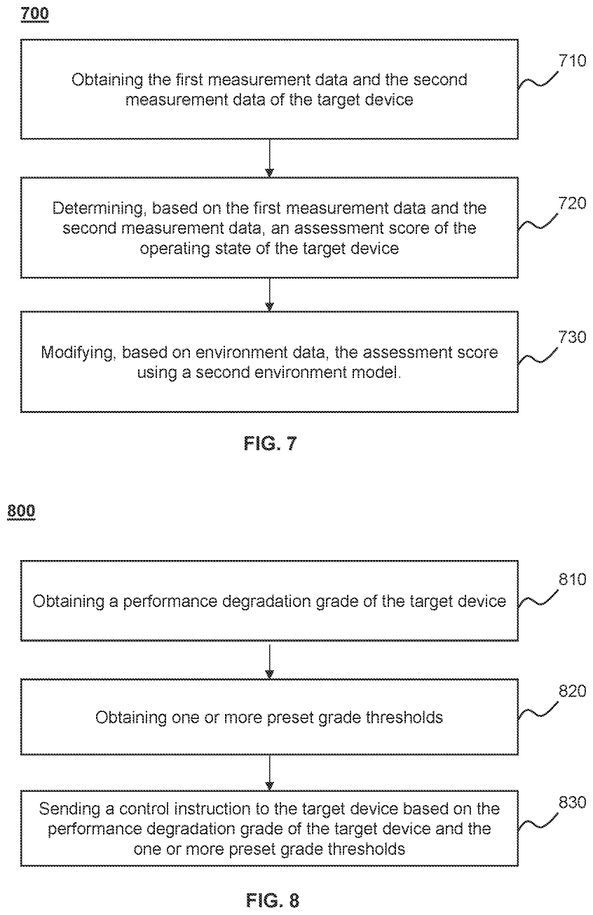

In some embodiments, the processing device 120 may perform degradation modeling to generate the performance degradation evaluation model. More descriptions regarding the generation of the performance degradation evaluation model may be found elsewhere in the present disclosure. See, e.g., FIG. 7 and relevant descriptions thereof.

In some embodiments, the processing device 120 may send a control instruction to the reference device 130. In some embodiments, the processing device 120 may control the reference device 130 to collect the first and/or second sample measurement data. In some embodiments, the processing device 120 may control the reference device 130 to collect sample image data by performing a scan. In some embodiments, the processing device 120 may control the reference device 130 to modify the first operating parameter(s) and/or one or more second operating parameters to generate the first and/or second sample measurement data. In some embodiments, the processing device 120 may send an operation and maintenance instruction to the target device 130 based on the operating state of the target device 130. The operation and maintenance instruction may instruct the target device 110 to perform certain operations including, for example, modifying the first operating parameter(s) and the second operating parameter(s) of the target device 130, stopping operating, or the like.

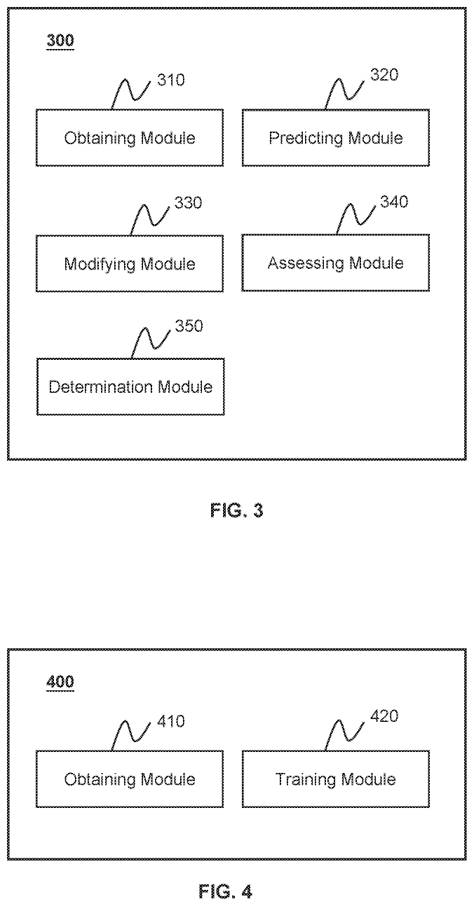

FIGS. 3 and 4 are schematic block diagrams illustrating exemplary processing devices according to some embodiments of the present disclosure. In some embodiments, a processing device 300 shown in FIG. 3 and a processing device 400 shown in FIG. 4 may be embodiments of the processing device 120 as described in connection with FIGS. 1 and 2. The processing device 300 may be configured to monitor the operating state of a target device, and the processing device 400 may be configured to generate one or more models for the processing device 300 to use in device monitoring. In some embodiments, the processing device 300 and the processing device 400 may be implemented on the same processing unit (e.g., a processor or a CPU) or different processing units. For example, the processing device 300 may be implemented on a processing device of a client (e.g., a buyer of a medical device), and the processing device 400 may be implemented on a processing device of a vendor (e.g., a manufacturer of the medical device or a vendor of the model(s)).

As shown in FIG. 3, the processing device 300 may include an obtaining module 310, a predicting module 320, a modifying module 330, an assessing module 340, and a determination module 350.

In some embodiments, the obtaining module 310 may be configured to obtain first measurement data relating to one or more first operating parameters of the target device. More descriptions regarding the first measurement data may be found elsewhere in the present disclosure. See, e.g., 510 and relevant descriptions thereof.

In some embodiments, the obtaining module 310 may be further configured to obtain a correlation model corresponding to the target device. In some embodiments, the correlation model may be generated based on first sample measurement data relating to the first operating parameter(s) and the second operating parameter(s) of a reference device. More descriptions regarding the correlation model may be found elsewhere in the present disclosure. See, e.g., 520 and relevant descriptions thereof.

In some embodiments, the obtaining module 310 may be further configured to obtain environment data of the target device. More descriptions regarding the environment data may be found elsewhere in the present disclosure. See, e.g., 540 and relevant descriptions thereof.

In some embodiments, the obtaining module 310 may be further configured to obtain the first measurement data and the second measurement data of the target device. The first measurement data may relate to the first operating parameter(s) of the target device, and the second measurement data may relate to the second operating parameter(s) of the target device. More descriptions regarding the first measurement data and the second measurement data may be found elsewhere in the present disclosure. See, e.g., 710 and relevant descriptions thereof.

In some embodiments, the obtaining module 310 may be configured to obtain one or more first parameter values relating to one or more operating parameters of the target device. More descriptions regarding the first parameter value(s) and the operating parameter(s) may be found elsewhere in the present disclosure. See, e.g., 910 and relevant descriptions thereof.

The predicting module 320 may be configured to predict, based on the first measurement data and the correlation model, second measurement data relating to the second operating parameter(s) of the target device. More descriptions regarding predicting the second measurement data relating to the second operating parameter(s) may be found elsewhere in the present disclosure. See, e.g., 530 and relevant descriptions thereof.

The modifying module 330 may be configured to modify, based on the environment data and a first environment model, the second measurement data. More descriptions regarding modifying the second measurement data may be found elsewhere in the present disclosure. See, e.g., 550 and relevant descriptions thereof. In some embodiments, the modifying module 330 may be further configured to modify, based on the environment data of the target device, the assessment score using a second environment model. More descriptions regarding modifying the assessment score may be found elsewhere in the present disclosure. See, e.g., 730 and relevant descriptions thereof.

The assessing module 340 may be configured to determine, based on the first measurement data and the second measurement data, the assessment score of the operating state of the target device. More descriptions regarding determining the assessment score may be found elsewhere in the present disclosure. See, e.g., 720 and relevant descriptions thereof. In some embodiments, the assessing module 340 may be configured to modify, based on the environment data of the target device, the assessment score using a second environment model.

The determination module 350 may be configured to obtain an operating parameter determination model corresponding to the target device. The determination module 350 may be further configured to determine, based on the one or more first parameter values and the operating parameter determination model, one or more second parameter values relating to the operating parameter(s) to be used by the target device at a second time after the first time. More descriptions regarding the operating parameter determination model and determining the second parameter value(s) may be found elsewhere in the present disclosure. See, e.g., 920, 930, and relevant descriptions thereof.

As shown in FIG. 4, the processing device 400 may include an obtaining module 410 and a training module 420.

The obtaining module 410 may be configured to obtain a plurality of first training samples. More descriptions regarding the plurality of first training samples may be found elsewhere in the present disclosure. See, e.g., 520, 530, and relevant descriptions thereof. In some embodiments, the obtaining module 410 may be further configured to a plurality of second training samples. More descriptions regarding the plurality of second training samples may be found elsewhere in the present disclosure. See, e.g., 550 and relevant descriptions thereof. In some embodiments, the obtaining module 410 may be further configured to a plurality of third training samples. More descriptions regarding the plurality of third training samples may be found elsewhere in the present disclosure. See, e.g., 720 and relevant descriptions thereof. In some embodiments, the obtaining module 410 may be further configured to a plurality of fourth training samples. More descriptions regarding the plurality of fourth training samples may be found elsewhere in the present disclosure. See, e.g., 720 and relevant descriptions thereof. In some embodiments, the obtaining module 410 may be further configured to a plurality of fifth training samples. More descriptions regarding the plurality of fifth training samples may be found elsewhere in the present disclosure. See, e.g., 730 and relevant descriptions thereof. In some embodiments, the obtaining module 410 may be further configured to a plurality of sixth training samples. More descriptions regarding the plurality of sixth training samples may be found elsewhere in the present disclosure. See, e.g., 920 and relevant descriptions thereof.

The training module 420 may be configured to generate the correlation model by training the preliminary correlation model based on a plurality of first training samples. More descriptions regarding generating the correlation model may be found elsewhere in the present disclosure. See, e.g., 520 and relevant descriptions thereof. In some embodiments, the training module 420 may be configured to generate the first environment model by training a preliminary first environment model based on the plurality of second training samples. More descriptions regarding generating the first environment model may be found elsewhere in the present disclosure. See, e.g., 550 and relevant descriptions thereof. In some embodiments, the training module 420 may be configured to generate the performance evaluation model by training a preliminary performance evaluation model based on the plurality of third training samples. More descriptions regarding generating the performance evaluation model may be found elsewhere in the present disclosure. See, e.g., 720 and relevant descriptions thereof. In some embodiments, the training module 420 may be configured to generate the second environment model by training a preliminary second environment model based on the plurality of fifth training samples. More descriptions regarding generating the second environment model may be found elsewhere in the present disclosure. See, e.g., 730 and relevant descriptions thereof. In some embodiments, the training module 420 may be configured to generate the operating parameter determination model by training the preliminary operating parameter determination model based on the plurality of sixth training samples. More descriptions regarding generating the operating parameter determination model may be found elsewhere in the present disclosure. See, e.g., 920 and relevant descriptions thereof.

In some embodiments, the processing device 300 and/or the processing device 400 may share two or more of the modules, and any one of the modules may be divided into two or more units. For instance, the processing devices 300 and 400 may share a same obtaining module, that is, the obtaining module 310 and the obtaining module 410 are a same module. In some embodiments, the processing device 300 and/or the processing device 400 may include one or more additional modules, such as a storage module (not shown) for storing data. In some embodiments, the processing device 300 and the processing device 400 may be integrated into one processing device.

FIG. 5 is a flowchart illustrating an exemplary process for determining second measurement data relating to one or more second operating parameters of a target device according to some embodiments of the present disclosure. In some embodiments, process 500 may be implemented as a set of instructions (e.g., an application) stored in a storage device. The processing device 300 may execute the set of instructions, and when executing the instructions, the processing device 300 may be configured to perform the process 500.

In 510, the processing device 300 (e.g., the obtaining module 310) may obtain first measurement data relating to one or more first operating parameters of the target device.

As described above, the target device may be a device, such as a medical device, that is needed to be monitored. More descriptions regarding the target device may be found elsewhere in the present disclosure. See, e.g., FIG. 1 and relevant descriptions thereof.

The first measurement data may be collected by one or more first sensors (e.g., the first sensor(s) 112A) mounted on the target device. For example, the first measurement data may include parameter value(s) of the first operating parameter(s) detected by the one or more first sensors at a measurement time or period. In some embodiments, exemplary first operating parameters may include a current, a voltage, an operating speed, an operating power, a rotary speed, or the like, or any combination thereof.

In some embodiments, the first operating parameter(s) may include parameter values collected by all first sensors mounted on the target device, or a portion of the parameter values, wherein the portion of the parameter values may be selected automatically or manually. In some embodiments, the first operating parameter(s) may include parameter(s) that have a big influence on the operating of the target device and can be measured by the one or more first sensors. Merely as an example, abnormal first measurement data of the first operating parameter(s) may have a serious influence on the result produced by the target device, and/or cause device failure and other serious damage.

In some embodiments, the first measurement data relating to one or more first operating parameters may partly indicate the operation status of the target device. In order to improve the accuracy of device monitoring, the second measurement data relating to the one or more second operating parameters may be determined by performing the following operations. In this way, the operating state of the target device may be monitored based on the combination of the first and second measurement data even if the second sensor(s) for measuring the second operating parameter(s) are not installed on the target device or the second sensor(s) are installed on the target device but fail.

In 520, the processing device 300 (e.g., the obtaining module 310) may obtain a correlation model corresponding to the target device. In some embodiments, the correlation model may be generated based on first sample measurement data relating to the first operating parameter(s) and the second operating parameter(s) of a reference device.

In some embodiments, the reference device may include one or more first sensors that are the same as the one or more first sensors of the target device. The reference device may also be equipped with one or more additional sensors (i.e., second sensors) compared with the target device. The second sensor(s) may be configured for collecting the first sample measurement data relating to the second operating parameter(s). In some embodiments, the second operating parameter(s) may include parameter(s) that can not be set by the user, such as the temperature. In some embodiments, the second operating parameter(s) may include parameter(s) that have a light influence on the result of the target device but have a relatively bigger influence on the machine life.

In some embodiments, the first sensor(s) and the second sensor(s) of the reference device may collect the first sample measurement data relating to the first operating parameter(s) and the second operating parameter(s). The first sample measurement data may be used to generate the correlation model corresponding to the target device. In some embodiments, the reference device may send the first sample measurement data to the processing device 400. The processing device 400 may train a preliminary correlation model using the first sample measurement data to generate the correlation model.

In some embodiments, the processing device 400 (e.g., the training module 420) may be configured to generate the correlation model by training the preliminary correlation model based on a plurality of first training samples. Each of the plurality of first training samples may include first sample measurement data relating to the first operating parameter(s) and first sample measurement data relating to the second operating parameter(s) that are collected at a time point or during a period. In model training, the first sample measurement data relating to the first operating parameter(s) may be used as an input, the first sample measurement data relating to the second operating parameter(s) may be used as the training ground truth, and the correlation model may be generated by iteratively updating the preliminary correlation model so that the difference between model output of the preliminary correction model and the training ground truth is minimized (e.g., smaller than a threshold).

In some embodiments, the processing device 300 may obtain environment data of the target device. The environment data may include value(s) of one or more environment parameters of the environment of the target device. Merely as an example, the environment parameter may include a temperature, an air humidity, an atmospheric pressure, an electromagnetic interference, an altitude, an air pH, a power supply current stability, or the like, or any combination thereof.

The processing device 300 may further select, from a plurality of candidate correlation models each of which corresponds to one of a plurality of types environment, a candidate correlation model as the correlation model based on the environment data. For example, the plurality of types of the environment may include a high-temperature environment, a low-temperature environment, a normal temperature environment, a high humidity environment, a high-altitude environment, a high electromagnetic field environment, or the like, or any combination thereof.

A candidate correlation model corresponding to a type of environment may be used to predict the second operating parameter(s) of a device in the type of environment. In some embodiments, the processing device 400 may generate the candidate correlation model based on the first sample measurement data collected under the type of environment. In some embodiments, the plurality of first training samples may further include sample environment data of the reference device when the first sample measurement data are collected in the plurality of types of environment. In model training, the first sample measurement data relating to the first operating parameter(s) and the sample environment data of the reference device may be used as the input, the first sample measurement data relating to the second operating parameter(s) may be used as the training ground truth, and the candidate correlation model may be generated by iteratively updating a preliminary candidate correlation model so that the difference between model output of the preliminary candidate correction model and the training ground truth is minimized (e.g., smaller than a threshold).

In some embodiments, different types of environment may be distinguished from each other based on one or more environment parameters. For example, each type of environment may correspond to specific range(s) of the environment parameter(s). The processing device 300 may determine the type of environment of the target device by comparing the environment parameter(s) of the target device with the one or more ranges of the environment parameter(s). The processing device 300 may further select the candidate correlation model corresponding to the type of environment of the target device as the final correlation model. In some embodiments, an environment parameter may have a weight factor (e.g., a weight factor set by a user). For each of the plurality of candidate correlation models, the processing device 300 may calculate a matching score based on the environment data of the target device, the one or more ranges of the environment parameter(s), and the weight factor(s). The processing device 300 may compare the matching scores of the plurality of candidate correlation models, and select one candidate correlation model with the highest matching score as the final correlation model.

In 530, the processing device 300 (e.g., the predicting module 320) may predict, based on the first measurement data and the correlation model, second measurement data relating to the second operating parameter(s) of the target device.

The second measurement data may be measurement data predicted by the correction model. For example, the second measurement data may include predicted parameter value(s) of the second operating parameter(s) of the target device at the measurement time or period. In some embodiments, the processing device 300 may input the first measurement data relating to the first operating parameter(s) into the correlation model. The correlation model may output the second measurement data relating to the second operating parameter(s) of the target device.

In some embodiments, the processing device 300 may obtain environment data of the target device. The processing device 300 may input the environment data of the target device and the first measurement data relating to the first operating parameter(s) into the correlation model. The correlation model may output the second measurement data relating to the second operating parameter(s) of the target device. In such cases, the correlation model may be generated further based on sample environment data of the reference device. Merely by way of example, each first training sample of the correlation model may include the first sample measurement data relating to the first and second operating parameters of the reference device and also sample environment data of the reference device. In model training, the sample environment data, together with the first sample measurement data relating to the first operating parameter(s), may be used as the input of the preliminary correlation model.

In 540, the processing device 300 (e.g., the obtaining module 310) may obtain environment data of the target device.

In some embodiments, the environment data of the target device may be collected by one or more environment sensors mounted in the environment around the target device at the measurement time or period. In some embodiments, the environment data of the target device may be determined or received by the processing device 300 from a reference source. For example, the altitude may be determined based on the location of the target device. As another example, the atmospheric pressure may be determined based on weather data published by the weather bureau.

In 550, the processing device 300 (e.g., the modifying module 330) may modify, based on the environment data and a first environment model, the second measurement data.

The first environment model may be used to modify the second measurement data relating to the second operating parameter based on the environment data of the target device.

As described in connection with operation 530, the second measurement data may include the predicted parameter value(s) of the second operating parameter(s) of the target device. In some embodiments, at least one of the predicted parameter value(s) may be modified based on the environment data and the first environment model. For illustration purposes, the modification of a predicted parameter value of a second operating parameter P is described as an example.

In some embodiments, the first environment model may include a plurality of association rules between a first operating parameter Q and the second operating parameter P. Each of the plurality of association rules may correspond to one of the plurality of types of environment. The association rule corresponding to a certain type of environment may indicate a correlation between the first operating parameter and the second operating parameter in the certain type of environment.

Merely as an example, in a high-temperature environment, the pressure inside the target device is associated with whether the liquid helium inside the target device leaks. As another example, under different ambient temperatures, the ratio between the current of the target device and the temperature of the target device may be different. For example, when the ambient temperature is 10-20° C., the ratio between the current and the temperature of the target device may be 1:1.5; and when the ambient temperature is 10-30° C., the ratio between the current and the temperature of the target device may be 1:3.

In some embodiments, the processing device 300 may select, from the plurality of association rules, a target association rule corresponding to the environment of the target device based on the environment data of the target device. The processing device 300 may further modify the precited parameter value of the second operating parameter P based on the target association rule. For example, the processing device 300 may determine a reference value or a reference range of the second operating parameter P based on the target association rule and the first measurement data of the first operating parameter Q. If a difference between the predicted parameter value of the second operating parameter P and the reference value or the reference range exceeds a threshold, the processing device 300 may modify the predicted parameter value of the second operating parameter P to be in line with the reference value or the reference range of the second operating parameter P. As another example, the processing device 300 may determine a relationship between the first measurement data of the first operating parameter Q and the predicted parameter value of the second operating parameter P. If the relationship does not fit the target association rule, the processing device 300 may modify the predicted parameter value of the second operating parameter P to be in line with the association rule.

Merely by way of example, the first operating parameter Q may be the current, and the second operating parameter P may be the temperature. If the ambient temperature of the target device is 25° C., an association rule specifying that the ratio between the current and the temperature is 1:3 may be selected as the target association rule. The processing device 300 may determine a predicted temperature of the target device using the correlation model based on the current of the target device. The processing device 300 may determine a ratio between the current and the predicted temperature of the target device. If the difference between the ratio and ⅓ exceeds a threshold value, the processing device 300 may modify the predicted temperature so that a difference between ⅓ and a ratio of the modified predicted temperature to the current is smaller than the threshold value.

In some embodiments, the first environment model may be generated by training a plurality of second training samples. Each of the plurality of second training samples may include sample environment data of the reference device, first sample measurement data relating to the first operating parameter(s), and one or more second operating parameters of the reference device collected that are collected at a time point or during a period. In some embodiments, the environment of the reference device may be set as a plurality of different sample environments. In some embodiments, the plurality of different sample environments may include high-temperature environment, low-temperature environment, high humidity environment, high altitude environment, high electromagnetic field environment, and so on. In some embodiments, for each of the plurality of different sample environments, the processing device 400 may generate a first environment sub-model based on the second training samples collected under the type of environment. In some embodiments, each of the first environment sub-models may correspond to one of the candidate correlation models.

In some embodiments, the processing device 400 (e.g., the training module 420) may be configured to generate the first environment model by training a preliminary first environment model based on the plurality of second training samples. In some embodiments, the processing device 400 may train a preliminary first environment model based on the sample environment data of the reference device, the first sample measurement data relating to the first operating parameter(s), and one or more second operating parameters of the reference device to generate one or more association rules between the first operating parameter(s) and the second operating parameter(s) under the sample environment data.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations of the process 500 may be omitted and/or one or more additional operations may be added. Merely as an example, operations 540 and 550 may be omitted. As another example, operation 550 may be omitted and operation 540 may be executed before operation 530.

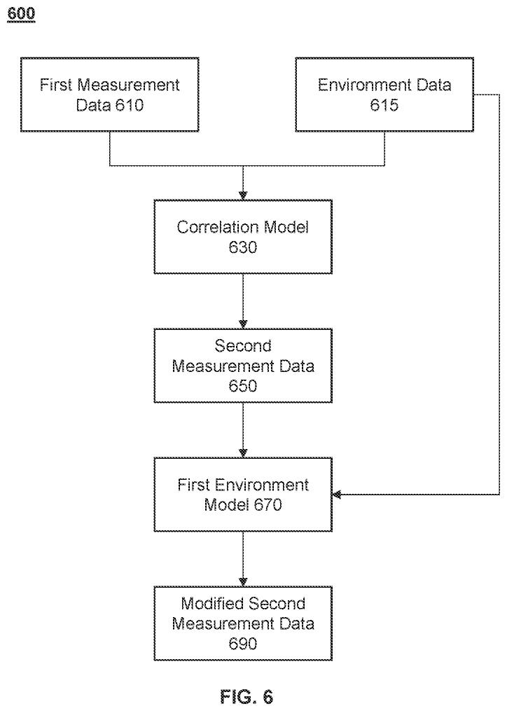

FIG. 6 is a schematic diagram illustrating an exemplary process for determining second measurement data according to some embodiments of the present disclosure. Process 600 illustrated in FIG. 6 may be an exemplary embodiment of the process 500 as described in connection with FIG. 5.

As shown in FIG. 6, first measurement data 610 relating to one or more first operating parameters of the target device and environment data 615 of the target device may be inputted into a correlation model 630. The correlation model 630 may output second measurement data 650 relating to one or more second operating parameters of the target device. In some embodiments, the input of the correlation model 630 may only include the first measurement data 610. Optionally, the correlation model 630 may be a candidate correlation model selected from the plurality of candidate correlation models based on the environment data 615.

The second measurement data 650 may then be modified based on the environment data 615 using a first environment model 670. For example, the environment data 615 may be inputted into the first environment model 670 to obtain an output result that is used to determine whether the second measurement data 650 is accurate. For example, the output may include a reference value or a reference range of a second operating parameter or an association rule between the second operating parameter and at least part of the first operating parameter(s). When it is determined that the second measurement data 650 is not accurate based on the output, the second measurement data 650 may be adjusted based on the output to obtain the modified second measurement data 690.

FIG. 7 is a flowchart illustrating an exemplary process for evaluating an operating state of a target device according to some embodiments of the present disclosure. In some embodiments, process 700 as shown in FIG. 7 may be performed after operation 530 to evaluate the operating state of the target device based on the first measurement data and the second measurement data. Alternatively, the process 700 as shown in FIG. 7 may be performed after operation 550 to evaluate the operating state of the target device based on the first measurement data and the modified second measurement data. For illustration purposes, the implementation of the process 700 based on the first measurement data and the second measurement data is described hereinafter.

In 710, the processing device 300 (e.g., the obtaining module 310) may obtain the first measurement data and the second measurement data of the target device. The first measurement data may relate to the first operating parameter(s) of the target device, and the second measurement data may relate to the second operating parameter(s) of the target device. More descriptions regarding the first measurement data and the second measurement data may be found elsewhere in the present disclosure, e.g., FIGS. 1, 2, and 5.

In 720, the processing device 300 (e.g., the assessing module 340) may determine, based on the first measurement data and the second measurement data, an assessment score of the operating state of the target device.

The assessment score may indicate whether the target device is in a desired operating state (e.g., a normal operating state). For example, the higher the assessment score is, the better performance the target device has. The assessment score may be represented in the form of a number, a level, a rating, or the like. In some embodiments, the assessment score may be used to determine a performance degradation grade that indicates the degradation degree of the target device.

In some embodiments, the assessment score of the target device may be determined manually based on the first measurement data and the second measurement data. In some embodiments, each operating parameter of the first operating parameter(s) and the second operating parameter(s) may have a corresponding reference value or range. For each operating parameter, the processing device 300 may compare the value of the operating parameter with its corresponding reference value or range, and determine a score of the operating parameter based on a comparison result. The processing device 300 may assess the operating state of the target device based on the score of each operating parameter. In some embodiments, each operating parameter may have a weight factor. The processing device 300 may assess the operating state of the target device based on the score and the weight factor of each operating parameter.

In some embodiments, the processing device 300 may input the first measurement data and the second measurement data into a performance evaluation model. The performance evaluation model may output the assessment score of the operating state of the target device.

In some embodiments, the performance evaluation model may be generated based on a plurality of third training samples. Each of the plurality of third training samples may include second sample measurement data of the reference device and a sample assessment score of an operating state of the reference device. The second sample measurement data of the reference device may be the same as or different from the first sample measurement data of the reference device. In some embodiments, the sample assessment score may be determined based on sample image data collected by the reference device under the second sample measurement data. For example, the reference device may be directed to perform a CT scan on a sample subject under a plurality of operating parameters to collect a CT image of the sample subject. The CT image may be displayed to a user, and the user may input a sample assessment score of the operating state of the CT device under the operating parameters based on the quality of the CT image. Alternatively, the sample assessment score may be determined by the processing device 400 by analyzing one or more quality parameters of the CT image. In some embodiments, the processing device 400 (e.g., the training module 420) may be configured to generate the performance evaluation model by training a preliminary performance evaluation model based on the plurality of third training samples. In model training, the second sample measurement data may be used as an input, the sample assessment score may be used as the training ground truth, and the performance evaluation model may be generated by iteratively updating a preliminary performance evaluation model so that the difference between model output of the preliminary performance evaluation model and the training ground truth is minimized (e.g., smaller than a threshold). By using the image data to determine the sample assessment score, the output of the performance evaluation model may reflect the imaging quality of the target device. In this way, the operation state evaluation performed using the performance evaluation model may be more aligned with actual application needs and user requirements.

In some embodiments, the performance evaluation model may include a performance degradation evaluation model. The performance degradation evaluation model may be used to determine the performance degradation score of the target device. In some embodiments, the processing device 300 may generate an operation and maintenance instruction for the target device based on the degradation degree of the target device. The operation and maintenance instruction may include, for example, modifying the first operating parameter(s) and the second operating parameter(s) of the target device or stopping the target device. In some embodiments, the change of the parameter values of some operating parameters of the target device may affect the performance and service life of the target device. These operating parameters may be used for determining the performance degradation score.

In some embodiments, the higher the performance degradation score is, the higher the degradation degree of the target device may be. In some embodiments, a performance degradation grade may include a plurality of grades, for example, grade A, grade B, grade C, and so on. The processing device 300 may determine the performance degradation grade of the target device based on the performance degradation score. In some embodiments, the performance degradation score outputted by the performance degradation evaluation model may be a percentage. In some embodiments, the performance degradation score 80%-100% may correspond to grade A, the performance degradation score 50%-80% may correspond to grade B, and the performance degradation score 0%-50% may correspond to grade C. Merely as an example, when the performance degradation score outputted by the performance degradation evaluation model is 60%, the performance degradation grade may be grade B. In some embodiments, the performance degradation evaluation model may directly output the performance degradation grade.

In some embodiments, the processing device 300 may input the first measurement data and the second measurement data into the performance degradation evaluation model. The performance degradation evaluation model may output the performance degradation score of the target device. In some embodiments, the performance degradation evaluation model may be generated based on a plurality of fourth training samples. Each of the plurality of fourth training samples may include third sample measurement data of the reference device and a sample performance degradation score of the reference device. The third sample measurement data of the reference device may be the same as or different from the second sample measurement data of the reference device. In some embodiments, the reference device may be assembled multiple times to have different performance degradation scores, for example, using a plurality of components with different aging degrees (e.g., different using durations and/or the operating environments). Sample measurement data of the reference device having a specific degradation score may be collected as third sample measurement data of a training sample.

In 730, the processing device 300 (e.g., the assessing module 340 or the modifying module 330) may modify, based on the environment data of the target device, the assessment score using a second environment model.

In some embodiments, the second environment model may indicate the effect of the environment on the operating state of a device. In some embodiments, the processing device 300 may input the environment data of the target device into the second environment model. The second environment model may output an adjustment score. The processing device 300 may modify the assessment score based on the adjustment score, e.g., by subtracting the adjustment score from the assessment score. Merely as an example, the assessment score outputted by the performance evaluation model may be 75. The target device may be in an environment with serious battery interference. The second environment model may output an adjustment score 20. The processing device 300 may modify the assessment score by subtracting the adjustment score 20 from the assessment score 75 to obtain a modified assessment score 55.

In some embodiments, the second environment model may be generated based on a plurality of fifth training samples. In some embodiment, each of the plurality of fifth training samples may include sample environment data of the reference device and a sample adjustment score. In some embodiments, the sample adjustment score may be determined by a user based on experience or existing device data. In some embodiments, the processing device 400 (e.g., the training module 420) may be configured to generate the second environment model by training a preliminary second environment model based on the plurality of fifth training samples. In model training, the sample environment data may be used as an input, the sample adjustment score may be used as the training ground truth, and the second environment model may be generated by iteratively updating the preliminary second environment model so that the difference between model output of the preliminary correction model and the training ground truth is minimized (e.g., smaller than a threshold).

In some embodiments, operation 730 may be omitted. In some embodiments, the assessment score may be determined merely based on the first measurement data.

FIG. 8 is a flowchart illustrating an exemplary process for determining a control instruction for a target device according to some embodiments of the present disclosure. In some embodiments, process 800 shown in FIG. 8 may be implemented after operation 720 based on the performance degradation grade. Alternatively, the process 800 may be implemented after operation 730 based on the modified performance degradation grade. For illustration purposes, the implementation of the process 800 based on the performance degradation grade is described hereinafter.

In 810, the processing device 300 may obtain the performance degradation grade of the target device.

In some embodiments, the performance degradation grade may be determined by the assessing module 340 by performing operation 720.

In 820, the processing device 300 may obtain one or more preset grade thresholds.

In some embodiments, the one or more preset grade thresholds may be preset by a user manually based on experience. In some embodiments, the one or more preset grade thresholds may include two grade thresholds, i.e., a first grade threshold and a second grade threshold. The first grade threshold may be lower than the second grade threshold.

In 830, the processing device 300 may send a control instruction to the target device based on the performance degradation grade of the target device and the one or more preset grade thresholds.

In some embodiments, the processing device 300 may compare the performance degradation grade of the target device with the one or more preset grade thresholds. For example, the processing device 300 may compare the performance degradation grade of the target device with the first and second preset grade thresholds. If the performance degradation grade of the target device is higher than the first grade threshold and lower than the second preset grade threshold, it may indicate that the degradation degree of the target device may be relatively low. In such cases, the processing device 300 may send an instruction to modify at least part of the first operating parameter(s) and the second operating parameter(s) of the target device to slow down the degradation process.

In some embodiments, if it is determined that the performance degradation grade of the target device reaches the second grade threshold, it may indicate that the degradation degree of the target device is relatively high and may affect the normal operating of the target device. In such cases, the processing device 300 may send an instruction to stop the target device. In some embodiments, when the performance degradation grade of the target device reaches the second grade threshold, the processing device 300 may send a warning to a terminal device. The warning may be in the form of a warning bell, a warning voice, a warning text, a warning video, and so on.

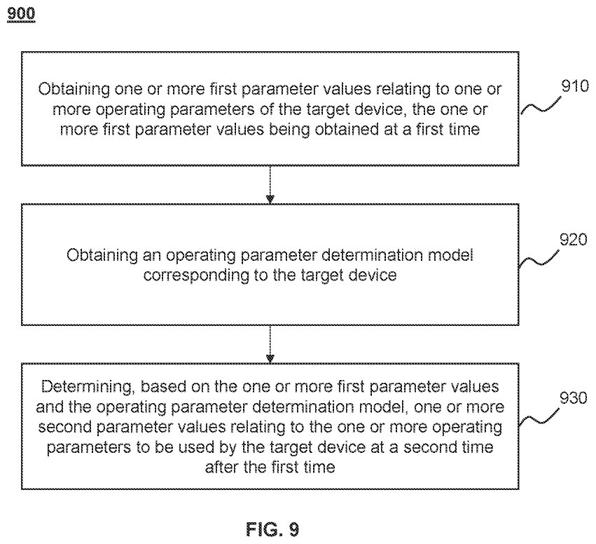

FIG. 9 is a flowchart illustrating an exemplary process for determining one or more second parameter values relating to one or more operating parameters to be used by the target device at a second time according to some embodiments of the present disclosure. In some embodiments, process 900 may be implemented as a set of instructions (e.g., an application) stored in a storage device. The processing device 300 may execute the set of instructions, and when executing the instructions, the processing device 300 may be configured to perform the process 900.

In 910, the processing device 300 (e.g., the obtaining module 310) may obtain one or more first parameter values relating to one or more operating parameters of the target device.

In some embodiments, the operating parameter(s) may include one or more first operating parameters and one or more second operating parameters. The first parameter value(s) relating to the first operating parameter(s) of the target device may be measured by one or more first sensors mounted on the target device. The first parameter value(s) relating to the second operating parameter(s) of the target device may be predicted by a correlation model based on the first parameter value(s) relating to the first operating parameter(s). More descriptions regarding the correlation model may be found elsewhere in the present disclosure, e.g., FIG. 5. In some embodiments, the operating parameter(s) may only include the first operating parameter(s).

In some embodiments, the first parameter value(s) may reflect the operating state of the target device at a first time (e.g., a current time). For example, the first parameter value(s) relating to the first operating parameter(s) may be measured by the one or more first sensors mounted on the target device at the first time. The first parameter value(s) relating to the second operating parameter(s) predicted based on the such one or more first parameter values may also reflect the target device's operating state at the first time. In some embodiments, the first time may be a time point or a time period. For example, the time period may be 2 seconds, 5 seconds, 10, seconds, 30 seconds, 1 minute, and so on.

In 920, the processing device 300 (e.g., the determination module 350) may obtain an operating parameter determination model corresponding to the target device.

In some embodiments, the operating parameter determination model may be generated by training a preliminary operating parameter determination model using a plurality of sixth training samples. In some embodiments, the plurality of sixth training samples may be generated by a plurality of sample devices having the same production batch or the same model number as the target device. Each of the plurality of sixth training samples may include one or more preliminary sample parameter values relating to the operating parameter(s) of a sample device and one or more target sample parameter values relating to the operating parameter(s) of the sample device. The one or more preliminary sample parameter values relating to the operating parameter(s) of the sample device may be parameter values measured (or predicted) at a time point or a time period. The one or more target sample parameter values relating to the operating parameter(s) of the sample device may be desired parameter value(s) of the operating parameter(s) of the sample device, which may be set by a user manually or determined by the processing device 400 (for example, based on parameter values of the sample device when the sample device has a desired operating state. In some embodiments, in the use history of the sample device, the user may adjust parameter values of the sample device to make the sample device in a desired operating state. The parameter values before the adjustment may be designated as the one or more preliminary sample parameter values, and the adjusted parameter values may be designated as the one or more target sample parameter values.

In some embodiments, the target sample parameter values of at least a portion of the sixth training samples may be determined by the processing device 400 by data analysis. Merely by way of example, for a training sample, the processing device 400 (e.g., the obtaining module 410) may obtain a plurality of sets of sample image data collected by the corresponding sample device in a period of using the sample device. In some embodiments, the period may be 1 month, 2 months, 3 months, six months, and so on. Each set of the plurality of sets of sample image data may be collected by the corresponding sample device under a reference operating state. The processing device 400 may further select one or more sets of sample image data whose qualities satisfy preset condition from the plurality of sets of sample image data. For example, the set(s) of sample image data may be selected based on an input of a user. As another example, the processing device 400 may select the one or more sets of sample image data based on one or more quality parameters (e.g., an image resolution, a signal-to-noise ratio) of the sets of sample image data. The processing device 400 may then determine the one or more target sample parameter values of the training sample based on the reference operating state of the sample device under which each selected set of sample image data is collected. For example, a reference operating state of the sample device may be defined by reference parameter value(s) of the operating parameter(s) of the sample device. For a specific operating parameter, the processing device 400 may determine a reference parameter value of the specific operating parameter of the sample device when each selected set of image data is collected. The processing device 400 may further designate an average value of the reference parameter value(s) of the specific operating parameter as the target sample parameter value of the specific operating parameter. By using the sets of sample image data to determine the target sample parameter value(s), the operating parameter determination model may output the target parameter value(s) under which a set of image data with preset quality can be collected by the target device. In this way, the parameter value recommendation using the operating parameter determination model may be more aligned with actual application needs and user requirements.

In some embodiments, the processing device 400 (e.g., the training module 420) may be configured to generate the operating parameter determination model by training the preliminary operating parameter determination model based on the plurality of sixth training samples. In model training, the one or more preliminary sample parameter values relating to the operating parameter(s) may be used as an input, and the one or more target sample parameter values relating to the operating parameter(s) may be used as the training ground truth, and the operating parameter determination model may be generated by iteratively updating the preliminary operating parameter determination model so that the difference between model output of the preliminary operating parameter determination model and the training ground truth is minimized (e.g., smaller than a threshold).

In some embodiments, the processing device 300 may obtain environment data of the target device. The processing device 300 may further select, from a plurality of candidate operating parameter determination models each of which corresponds to one of the plurality of types environment, a candidate operating parameter determination model as the operating parameter determination model based on the environment data. The selection of the candidate operating parameter determination model may be similar to the selection of the candidate correlation model as described in FIG. 5.

A candidate operating parameter determination model corresponding to a type of environment may be used to determine second parameter value(s) relating to operating parameter(s) to be used by the target device at the second time in the type of environment. In some embodiments, the processing device 400 may generate the candidate operating parameter determination model based on the preliminary sample parameter value(s) and the target sample parameter value(s) relating to the operating parameter(s) of a sample device under the type of environment. In some embodiments, for a candidate operating parameter determination model corresponding to a specific type of environment, the corresponding sixth training samples may further include sample environment data of the sample device in the specific type of environment. In model training, the preliminary sample parameter value(s) relating to the operating parameter(s) and the sample environment data of the sample device may be used as the input.

In 930, the processing device 300 (e.g., the determination module 350) may determine, based on the one or more first parameter values and the operating parameter determination model, one or more second parameter values relating to the operating parameter(s) to be used by the target device at a second time after the first time. The second parameter value(s) may be regarded as optimal or desired parameter value(s) to be used by the target device at the second time. In some embodiments, the second time may be a time point or a time period after the first time. In some embodiments, the processing device 300 may share the second parameter value(s) with the device that has the same production batch or the same model number as the target device.

In some embodiments, the processing device 300 may input the first parameter value(s) relating to the operating parameter(s) into the operating parameter determination model. The operating parameter determination model may output the second parameter value(s) relating to the operating parameter(s) of the target device.

In some embodiments, the processing device 300 may input the environment data of the target device and the first parameter value(s) into the operating parameter determination model. The operating parameter determination model may output the second parameter value(s) relating to the operating parameter(s) of the target device.

In some embodiments, the processing device 300 may modify the second parameter value(s) relating to the operating parameter(s) based on the environment data of the target device. In some embodiments, the processing device 300 may compare the environment data corresponding to the first parameter value(s) (or the first time) with the environment data corresponding to the second parameter value(s) (or the second time). The processing device 300 may modify the second parameter value(s) based on the comparison result. In some embodiments, the second parameter value(s) may be modified manually based on the second environment data of the target device. By modifying the second parameter value(s) based on the environment data, the modified second parameter value(s) may be more suitable for the environment of the target device at the second time.

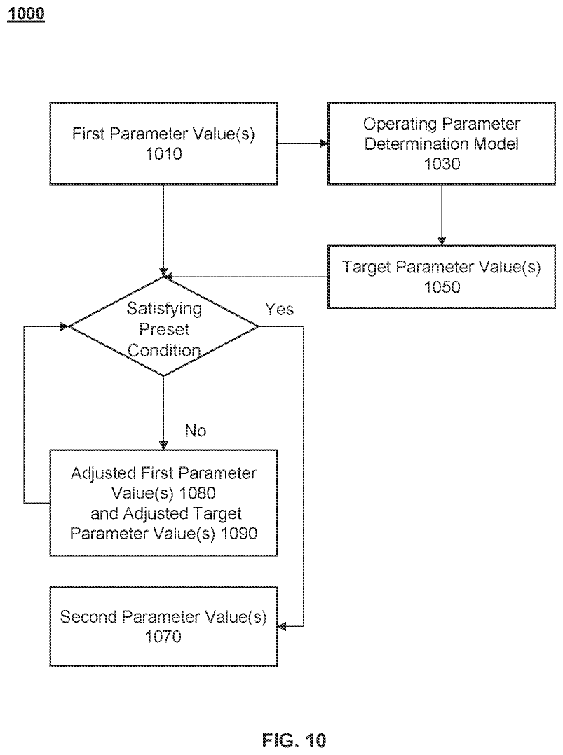

In some embodiments, the processing device 300 may determine one or more target parameter values relating to the operating parameter(s), based on the first parameter value(s), using the operating parameter determination model. The processing device 300 may further determine the second parameter value(s) based on the first parameter value(s) and the one or more target parameter values. For example, the target parameter value(s) may be directly designated as the second parameter value(s). As another example, the one or more second parameter values may be determined by performing process 1000 as shown in FIG. 10.

As shown in FIG. 10, the processing device 300 may input first parameter value(s) 1010 relating to the operating parameter(s) of the target device and optionally the environment data of the target device into an operating parameter determination model 1030. Target parameter value(s) 1050 relating to the operating parameter(s) of the target device may be determined based on an output of the operating parameter determination model 1030. The target parameter value(s) 1050 may be regarded as optimal or desired parameter value(s) to be used by the target device at the second time if the environment of the target device does not change from the first time to the second time. For example, the target device may be able to collect a set of image data with preset quality under the target parameter value(s) at the second time if the environment of the target device does not change from the first time to the second time. In some embodiments, the operating parameter determination model 1030 may directly output the target parameter value(s) 1050. Alternatively, the processing device 300 (e.g., the determination module 350) may determine the target parameter value(s) 1050 by processing the output of the operating parameter determination model 1030.

The processing device 300 may further determine whether the first parameter value(s) 1010 and the target parameter value(s) 1050 meet a preset condition. The preset condition may be used to ensure the proximity between the first parameter value(s) 1010 and the target parameter value(s) 1050. In some embodiments, for each operating parameter, a difference (denoted as the difference D) between the first parameter value and the target parameter value of the operating parameter may be determined, and a corresponding difference threshold may be obtained. The difference D may be determined by subtracting the first parameter value from the target parameter value or determining a ratio of the first parameter value to the target parameter value. The difference thresholds of different operating parameters may be the same or different. The difference threshold of an operating parameter may be a parameter value or a percentage. Merely by way of example, if the difference D is measured by a ratio of the first parameter value to the target parameter value, the difference threshold may be in the range of 0.99 to 1.01. For each operating parameter, the processing device 300 may compare the corresponding difference threshold with a difference between the first parameter value and the target parameter value of the operating parameter. In some embodiments, the processing device 300 may determine a count of operating parameters whose difference D is larger than the corresponding difference threshold. If the count is greater than a threshold value (e.g., 0), the processing device 300 may determine that the first parameter value(s) and the target parameter value(s) do not meet the preset condition. If the count is smaller than or equal to the threshold value, the processing device 300 may determine that the first parameter value(s) and the target parameter value(s) meet the preset condition.

If the preset condition is met, the processing device 300 may designate the target parameter value(s) 1050 as second parameter value(s) 1070.

If the preset condition is not met, the processing device 300 may determine adjusted first parameter value(s) 1080 and adjusted target parameter value(s) 1080. In some embodiments, for each operating parameter, the processing device 300 may adjust the first parameter value of the operating parameter based on its difference D to obtain an adjusted first parameter value of the operating parameter. For example, the adjusted first parameter value of an operating parameter may be a sum of the first parameter value and the difference D of the operating parameter determination model. As another example, the processing device 300 may adjust the first parameter value by increasing or decreasing the first parameter value with a product of an adjustment coefficient and the difference D. The adjustment coefficient of the difference may be, for example, 40%, 50%, 60%, 110%, 120%, and so on. In some embodiments, the processing device 300 may adjust the first parameter value by increasing or decreasing the first parameter value with a percentage of a ratio of the difference to the first parameter value. In some embodiments, the percentage of the ratio may be 50%, 60%, 70%, 80%, and so on.

The processing device 300 may input the adjusted first parameter value(s) 1080 and optionally adjusted environment data of the target device into the operating parameter determination model 1030, wherein the adjusted environment data may reflect the environment of the target device when the target device has been adjusted to the adjusted first parameter value(s) 1080. The operating parameter determination model 1030 may output the adjusted target parameter value(s) 1090. The processing device 300 may determine whether the adjusted first parameter value(s) and the adjusted target parameter value(s) meet the preset condition. In some embodiments, the processing device 300 may designate the adjusted target parameter value(s) as the second parameter value(s) in response to a determination result that the adjusted first parameter value(s) and the adjusted target parameter value(s) meet the preset condition. Otherwise, the adjustment of the first parameter value(s) and the target parameter value(s) may be iteratively performed until the latest adjusted first parameter value(s) and the latest adjusted target parameter value(s) satisfy the preset condition. In some occasions, the environment of the target device at the second time may be different from the environment of the target device at the first time, and the target parameter value(s) may not necessarily be suitable for the target device at the second time. By iteratively adjusting the first parameter value(s) to determine the second parameter value(s), instead of directly adjusting the first parameter value(s) to the target parameter value(s), the final second parameter value(s) may be more suitable for the environment of the target device at the second time.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer-readable program code embodied thereon.

A non-transitory computer-readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer-readable signal medium may be any computer-readable medium that is not a computer-readable storage medium and that may communicate, propagate, or transport a program for use by or in connection with an instruction execution system, apparatus, or device. Program code embodied on a computer-readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran, Perl, COBOL, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for device monitoring, comprising:
obtaining first measurement data relating to one or more first operating parameters of a target device;
obtaining a correlation model corresponding to the target device, the correlation model being generated based on first sample measurement data relating to the one or more first operating parameters and one or more second operating parameters of a reference device, the reference device being of a same type of device as the target device and equipped with one or more additional sensors compared with the target device, the one or more additional sensors being configured for collecting the first sample measurement data relating to the one or more second operating parameters; and
predicting, based on the first measurement data and the correlation model, second measurement data relating to the one or more second operating parameters of the target device.

2. The method of claim 1, wherein the method further comprises:
obtaining environment data of the target device; and
modifying, based on the environment data and a first environment model, the second measurement data.

3. The method of claim 2, wherein
the first environment model includes a plurality of association rules between the one or more first operating parameters and the one or more second operating parameters, each of the plurality of association rules corresponding to one of a plurality of types of environment, and
the modifying, based on the environment data and a first environment model, the second measurement data comprises:
selecting, from the plurality of association rules, a target association rule corresponding to an environment of the target device;
modifying, based on the first measurement data and the target association rule, the second measurement data.

4. The method of claim 1, the obtaining a correlation model corresponding to the target device further comprising:
obtaining environment data of the target device; and
selecting, from a plurality of candidate correlation models each of which corresponds to one of a plurality of types of environment, the correlation model based on the environment data.

5. The method of claim 1, wherein the predicting, based on the first measurement data and the correlation model, second measurement data relating to the one or more second operating parameters of the target device comprises:
obtaining environment data of the target device; and
predicting the second measurement data based on the first measurement data, the correlation model, and the environment data, the correlation model being generated based on sample environment data of the reference device.

6. The method of claim 1, further comprising:
assessing an operating state of the target device based on the first measurement data and the second measurement data.

7. The method of claim 6, the assessing an operating state of the target device based on the first measurement data and the second measurement data further comprising:
determining, based on the first measurement data and the second measurement data, an assessment score of the operating state of the target device using a performance evaluation model.

8. The method of claim 7, further comprising:
modifying, based on environment data, the assessment score using a second environment model.

9. The method of claim 7, wherein the performance evaluation model is obtained according to a process including:
obtaining a plurality of training samples, each of the plurality of training samples including second sample measurement data of the reference device and a sample assessment score of an operating state of the reference device, the sample assessment score being determined based on sample image data collected by the reference device under the second sample measurement data; and
generating the performance evaluation model by training a preliminary performance evaluation model using the plurality of training samples.

10. The method of claim 7, wherein the performance evaluation model includes a performance degradation evaluation model.

11. The method of claim 1, further comprising:
obtaining an operating parameter determination model corresponding to the target device; and
determining one or more parameter values of the one or more first operating parameters and the one or more second operating parameters to be used by the target device at a future time based on the first measurement data, the second measurement data, and the operating parameter determination model.

12. The method of claim 11, further comprising:
obtaining environment data of the target device, wherein the one or more parameter values of the one or more first operating parameters and the one or more second operating parameters to be used by the target device are determined further based on the environment data.

13. A system for device monitoring, comprising:
at least one storage device including a set of instructions; and
at least one processor configured to communicate with the at least one storage device, wherein, when the instructions are executed, the at least one processor is configured to instruct the system to perform operations, including:
obtaining first measurement data relating to one or more first operating parameters of the target device;
obtaining a correlation model corresponding to the target device, the correlation model being generated based on first sample measurement data relating to the one or more first operating parameters and one or more second operating parameters of a reference device, the reference device being of a same type of device as the target device and equipped with one or more additional sensors compared with the target device, the one or more additional sensors being configured for collecting the first sample measurement data relating to the one or more second operating parameters; and
predicting, based on the first measurement data and the correlation model, second measurement data relating to the one or more second operating parameters of the target device.

14. A method for device monitoring, comprising:
obtaining one or more first parameter values relating to one or more operating parameters of a target device, the one or more first parameter values reflecting an operating state of the target device at a first time;
obtaining an operating parameter determination model corresponding to the target device; and
determining, based on the one or more first parameter values and the operating parameter determination model, one or more second parameter values relating to the one or more operating parameters to be used by the target device at a second time after the first time.

15. The method of claim 14, wherein the determining, based on the one or more first parameter values and the operating parameter determination model, one or more second parameter values relating to the one or more operating parameters to be used by the target device at a second time after the first time comprises:
determining, based on the one or more first parameter values and the operating parameter determination model, one or more target parameter values relating to the one or more operating parameters; and
determining, based on the one or more first parameter values and the one or more target parameter values, the one or more second parameter values.

16. The method of claim 15, wherein the determining, based on the one or more first parameter values and the one or more target parameter values, the one or more second parameter values comprises:
determining whether the one or more first parameter values and the one or more target parameter values meet a preset condition;
in response to determining that the one or more first parameter values and the one or more target parameter values do not meet the preset condition,
for each operating parameter, determining a difference between the first parameter value and the target parameter value of the operating parameter; and
for each operating parameter, adjusting the first operating parameter value based on the corresponding difference to obtain an adjusted first parameter value of the operating parameter;
determining, based on the one or more adjusted first parameter values and the operating parameter determination model, one or more adjusted target parameter values of the one or more operating parameters;
determining whether the one or more adjusted first parameter values and the one or more adjusted target parameter values meet the preset condition;
in response to determining that the one or more adjusted first parameter values and the one or more adjusted target parameter values meet the preset condition, designating the one or more adjusted first parameter values as the one or more second parameter values.

17. The method of claim 14, further comprising:
obtaining environment data of the target device, and wherein the one or more second parameter values are determined further based on the environment data.

18. The method of claim 14, wherein the operating parameter determination model is obtained according to a process including:
obtaining a plurality of training samples, each of the plurality of training samples including one or more preliminary sample parameter values relating to the one or more operating parameters of a sample device and one or more target sample parameter values relating to the one or more operating parameters of the sample device; and
generating the operating parameter determination model by training a preliminary operating parameter determination model using the plurality of training samples.

19. The method of claim 18, wherein the obtaining a plurality of training samples comprises:
for each of at least a portion of the plurality of training samples,
obtaining a plurality of sets of sample image data each of which being collected by the corresponding sample device under a reference operating state;
selecting, from the plurality of sets of sample image data, one or more sets of sample image data whose qualities satisfy a preset condition;
determining the one or more target sample parameter values based on the reference operating state of the sample device under which each selected set of sample image data is collected.

20. The method of claim 14, wherein the one or more operating parameters includes one or more first operating parameters and one or more second operating parameters, and the obtaining one or more first parameter values relating to one or more operating parameters of the target device comprises:
obtaining the one or more first parameter values of the one or more first operating parameters measured by one or more first sensors mounted on the target device;
obtaining a correlation model corresponding to the target device, the correlation model being generated based on first sample measurement data relating to the one or more first operating parameters and the one or more second operating parameters of a reference device, the reference device being of a same type of device as the target device and equipped with one or more additional second sensors compared with the target device, the one or more additional second sensors being configured for collecting the first sample measurement data relating to the one or more second operating parameters; and
predicting, based on one or more first parameter values relating to the one or more first operating parameters and the correlation model, the one or more first parameter values relating to the one or more second operating parameters.
